(19) United States
(12) Patent Application Publication
(10) Pub. No.: US 2026/0267427 A1
(43) Pub. Date: Sep. 10, 2026

(54) APPARATUS FOR PRESS DETECTION AND ELECTRONIC DEVICE

(71) Applicant: SHENZHEN GOODIX TECHNOLOGY CO., LTD., Shenzhen (CN)

(72) Inventors: Ruilang HUANG, Shenzhen (CN); Jing WANG, Shenzhen (CN); Kai LIU, Shenzhen (CN); Xinli HUANG, Shenzhen (CN)

(73) Assignee: SHENZHEN GOODIX TECHNOLOGY CO., LTD., Shenzhen, Guangdong (CN)

(21) Appl. No.: 19/676,158

(22) Filed: May 13, 2026

Related U.S. Application Data
(63) Continuation of application No. PCT/CN2025/099460, filed on Jun. 6, 2025.

(30) Foreign Application Priority Data
Jun. 27, 2024 (WO) PCT/CN2024/101908

(51) Int. Cl. G06F 3/0354

(52) U.S. Cl. CPC G06F 3/03547

(57) ABSTRACT

An apparatus for press detection and an electronic device are provided. The apparatus for press detection comprises: a circuit board, a bracket, and a plurality of sensors; wherein a sensor comprises a first electrode disposed on a bottom surface of the circuit board and a second electrode connected to the bottom surface of the circuit board, a first accommodating groove is provided in a region around the sensor on the bottom surface of the circuit board; the bracket is fixed on a housing of the electronic device, and abuts against the second electrode; when the apparatus for press detection receives a pressing operation, the second electrode is configured to deform, such that each of the sensors generates a press signal; and the circuit board transmits the press signal to a control unit to enable the control unit to perform press detection based on the press signal.

### CROSS-REFERENCE

The present disclosure is a continuation of International Application No. PCT/CN2025/099460, filed on Jun. 6, 2025, which claims priority to a PCT Patent Application No. PCT/CN2024/101908, filed on June 27, 2024, the entire contents of which are incorporated herein by reference.

### TECHNICAL FIELD

Embodiments of the present disclosure relate to the technical field of a touch pad, and in particular to, an apparatus for press detection and an electronic device.

### BACKGROUND

A touch pad is a flat panel disposed on a C-cover of a notebook computer. The touch pad on the notebook computer can recognize a touch command and a press command. A user's finger, when sliding on a touch-sensitive region of the touch pad, can move the cursor in the notebook computer. When the user's finger presses on the touch pad, the touch pad can recognize the press command, so that the notebook computer implements a corresponding operation.

An existing touch pad recognizes a press command using a mechanical press structure in a semi-area press form or a single button form.

However, the single button form will occupy the area of the touch-sensitive region of the touch pad, thereby reducing the area of the touch-sensitive region, and the semi-area press form can recognize the press command only by pressing at a particular position, so that the existing touch pad exhibits poor user experience.

### SUMMARY

In view of the above, embodiments of the present disclosure provide an apparatus for press detection and an electronic device, to at least partially solve the above problems.

According to an embodiment in a first aspect of the present disclose, an apparatus for press detection is provided, wherein the apparatus is applied to an electronic device, and comprises: a circuit board, a bracket, and a plurality of sensors; wherein each of the sensors comprises a first electrode disposed on a bottom surface of the circuit board and a second electrode connected to the bottom surface of the circuit board, a first accommodating groove is provided in a region around each of the sensors on the bottom surface of the circuit board, for accommodating residual flux when the second electrode is welded to the circuit board; the bracket is fixed on a housing of the electronic device, and abuts against the second electrode; when the apparatus for press detection receives a pressing operation, the second electrode is configured to deform, changing a distance between the first electrode and the second electrode, such that each of the sensors generates a press signal; and the circuit board is configured to transmit the press signal to a control unit to enable the control unit to perform press detection based on the press signal.

According to an embodiment in a second aspect of the present disclosure, an electronic device is provided, comprising a housing and the apparatus for press detection according to an embodiment in the first aspect of the present disclosure; wherein the bracket in the apparatus for press detection is fixed on the housing.

The apparatus for press detection provided according to the embodiments of the present disclosure comprises a circuit board, a bracket, and a plurality of sensors. When the apparatus for press detection receives a pressing operation, a relative distance between a first electrode and a second electrode of each of the sensors changes, such that each of the sensors generates a press signal, and the circuit board can transmit the press signal to a control unit to recognize the pressing operation of a user. Since no physical button is provided, the touch-sensitive region has a larger area than the touch pad in the single button form in the prior art. Since the pressing position is not limited, the apparatus for press detection can generate the press signal upon receipt of the pressing operation. Therefore, compared with the touch pad in the semi-area press form in the prior art, the user can press anywhere without the need to press at a particular position, thereby improving the user experience. Moreover, a first accommodating groove is provided in a region around each of the sensors on a bottom surface of the circuit board, such that after the second electrode is welded to the circuit board, residual flux can be accommodated in the first accommodating groove, thereby preventing the flux from remaining on the surface of the circuit board and affecting the press detection sensitivity, and endowing the apparatus for press detection with high sensitivity.

### BRIEF DESCRIPTION OF DRAWINGS

To more clearly describe technical solutions in embodiments of the present disclosure or the prior art, drawings required to be used in the description of the embodiments or the prior art will be briefly introduced below. Apparently, the drawings in the description below are merely some embodiments disclosed in the embodiments of the present disclosure. For those of ordinary skills in the art, other drawings may also be obtained based on these drawings.

FIG. 1 is a schematic diagram of a touch pad in a single button form provided in an embodiment of the present disclosure;

FIG. 2 is a schematic diagram of an apparatus for press detection provided in an embodiment of the present disclosure;

FIG. 3 is a schematic diagram of a bracket provided in an embodiment of the present application;

FIG. 4 is a schematic diagram of a circuit board provided in an embodiment of the present disclosure;

FIG. 5 is a schematic diagram of a first accommodating groove provided in an embodiment of the present disclosure;

FIG. 6 is a schematic diagram of another first accommodating groove provided in an embodiment of the present disclosure;

FIG. 7 is a schematic diagram of a circuit board comprising a second accommodating groove provided in an embodiment of the present disclosure;

FIG. 8 is an enlarged section view of a local region of a circuit board provided in an embodiment of the present disclosure;

FIG. 9 is a schematic diagram of an electrical connection region provided in an embodiment of the present disclosure;

FIG. 10 is a schematic diagram of another electrical connection region provided in an embodiment of the present disclosure;

FIG. 11 is a schematic diagram of a second electrode provided in an embodiment of the present disclosure;

FIG. 12 is a section view of a second electrode provided in an embodiment of the present disclosure;

FIG. 13 is a schematic diagram of another apparatus for press detection provided in an embodiment of the present disclosure;

FIG. 14 is an exploded view of an apparatus for press detection provided in an embodiment of the present disclosure;

FIG. 15 is a schematic diagram of a silicone pad provided in an embodiment of the present disclosure;

FIG. 16 is a schematic diagram of a sensing portion provided in an embodiment of the present disclosure;

FIG. 17 is a schematic diagram of another circuit board provided in an embodiment of the present disclosure;

FIG. 18 is a schematic diagram of an apparatus for press detection comprising a feedback unit provided in an embodiment of the present disclosure; and

FIG. 19 is a section view of an electronic device provided in an embodiment of the present disclosure.

### DETAILED DESCRIPTION

To enable those skilled in the art to better understand technical solutions in embodiments of the present disclosure, the technical solutions in the embodiments of the present disclosure will be clearly described in detail below with reference to the drawings in the embodiments of the present disclosure. Apparently, the described embodiments are merely some, instead of all, of the embodiments of the present disclosure. All other embodiments obtained by those of ordinary skills in the art based on some embodiments among the embodiments of the present disclosure should be encompassed within the scope of protection of the embodiments of the present disclosure.

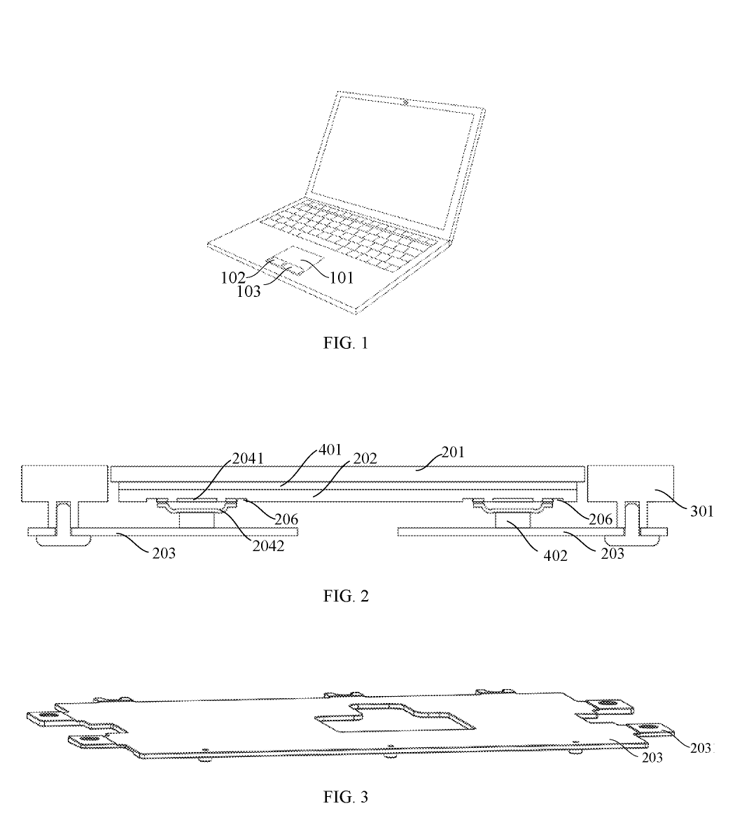

As mentioned above, a touch pad is a flat panel disposed on a C-cover of a notebook computer. The touch pad on the notebook computer can recognize a touch command and a press command. A user's finger, when sliding on a touch-sensitive region of the touch pad, can move the cursor in the notebook computer. When the user's finger presses on the touch pad, the touch pad can recognize the press command, such that the notebook computer implements a corresponding operation. An existing touch pad recognizes a press command using a mechanical press structure in a semi-area press form or a single button form. For example: FIG. 1 is a schematic diagram of a touch pad in a single button form provided in an embodiment of the present disclosure. As shown in FIG. 1, the touch pad in the single button form comprises two buttons. The user inputs a press command through the two buttons. Specifically, a left button 102 can simulate the left button of a mouse, and a right button 103 can simulate the right button of a mouse. However, the single button form will occupy a part of area of a touch-sensitive region 101 of the touch pad, thereby reducing the area of the touch-sensitive region 101, and the semi-area press form can recognize the press command only by pressing at a particular position. For example, the semi-area press form needs to simulate the left mouse button by pressing at a lower left corner, and simulate the right mouse button by pressing at a lower right corner, such that the existing touch pad exhibits poor user experience.

An embodiment of the present disclosure provides an apparatus for press detection, comprising a circuit board, a bracket, and a plurality of sensors. When the apparatus for press detection receives a pressing operation, a relative distance between a first electrode and a second electrode of each of the sensors changes, such that each of the sensors generates a press signal, and the circuit board can transmit the press signal to a control unit to recognize the pressing operation of a user. Since no physical button is provided, the touch-sensitive region has a larger area than the touch pad in the single button form in the prior art. Since the pressing position is not limited, the apparatus for press detection can generate the press signal upon receipt of the pressing operation. Therefore, compared with the touch pad in the semi-area press form in the prior art, the user can press anywhere without the need to press at a particular position, thereby improving the user experience. Moreover, a first accommodating groove is provided in a region around each of the sensors on a bottom surface of the circuit board, such that after the second electrode is welded to the circuit board, residual flux can be accommodated in the first accommodating groove, thereby preventing the flux from remaining on the surface of the circuit board and affecting the press detection sensitivity, and endowing the apparatus for press detection with high sensitivity.

The apparatus for press detection provided in the present disclosure will be introduced below with reference to embodiments.

FIG. 2 is a schematic diagram of an apparatus for press detection provided in an embodiment of the present disclosure. The apparatus for press detection is applied to an electronic device. As shown in FIG. 2, the apparatus for press detection comprises: a circuit board 202, a bracket 203, and a plurality of sensors. Each of the sensors comprises a first electrode 2041 and a second electrode 2042. The first electrode 2041 is disposed on a bottom surface of the circuit board 202. The second electrode 2042 is connected to the bottom surface of the circuit board 202. A first accommodating groove 206 is provided in a region around each of the sensors on the bottom surface of the circuit board 202. The first accommodating groove 206 is used for accommodating residual flux when the second electrode 2042 is welded to the circuit board 202. The bracket 203 is fixed on a housing 301 of the electronic device, and the bracket 203 abuts against the second electrode 2042. When the apparatus for press detection receives a pressing operation, the second electrode 2042 is configured to deform, changing a distance between the first electrode 2041 and the second electrode 2042, such that each of the sensors generates a press signal. The circuit board 202 can transmit the press signal to a control unit to enable the control unit to perform press detection based on the press signal. In an implementation, the press detection may include pressing operation detection and/or pressure detection.

The sensor is disposed between the circuit board 202 and the bracket 203, and the bracket 203 is fixed on the housing 301 of the electronic device. In an example, the bracket 203 may be made of a metal material. In another example, the bracket 203 may be a bracket 203 made of a plastic material. The bracket 203 may be fixed on the housing 301 of the electronic device by, e.g., bolting or snap-fitting. The specific fixing method is not limited here. It should be understood that the plurality of sensors may be distributed at different positions on the circuit board 202. In an implementation, the plurality of sensors may be uniformly distributed at an edge of the circuit board 202.

When the apparatus for press detection receives the pressing operation, for example: when user's finger applies a pressing force, the circuit board 202 shifts in the pressure direction and moves relative to the bracket 203. In this case, since the bracket 203 is fixed on the housing 301 of the electronic device, the circuit board 202 shifts relative to the bracket 203, the first electrode 2041 is disposed on the circuit board 202, and the second electrode 2042 abuts against the bracket 203. When the circuit board 202 shifts relative to the bracket 203, the second electrode 2042 is configured to deform, thereby changing the relative distance between the first electrode 2041 and the second electrode 2042, changing the capacitance of the sensor, and enabling the sensor to generate the press signal. After receiving the press signal sent from the sensor, the circuit board 202 transmits the press signal to the control unit. The control unit can recognize the press signal and implement the pressing operation based on the press signal. In an example, the control unit may be, e.g., a press detection chip provided on the circuit board 202, a touch chip provided on the circuit board 202, or a processor of the electronic device.

It should be understood that when the second electrode 2042 is welded to the circuit board 202 by the solder, a flux needs to be used. The flux can assist adhesion of the solder, such that the second electrode 2042 can be successfully welded to the bottom surface of the circuit board 202. However, due to the fluidity of the flux at a high temperature, after the welding of the second electrode 2042 is completed, some flux will remain on the circuit board 202. At least a part of the flux remaining on the circuit board 202 flows into the space between the first electrode 2041 and the second electrode 2042. Due to the viscosity of the flux, the second electrode 2042 fails to spring back, and due to the residual flux between the first electrode 2041 and the second electrode 2042, the signal generated between the deformed second electrode 2042 and the first electrode 2041 changes a little, thereby resulting in low pressure detection sensitivity. To address the above problems, the first accommodating groove 206 is disposed around the sensors on the bottom surface of the circuit board 202. In an implementation, the first accommodating groove 206 is disposed outside the second electrode 2042. After the second electrode 2042 is welded to the bottom surface of the circuit board 202, the residual flux can flow into the first accommodating groove 206, thereby reducing the residual flux on the bottom surface of the circuit board 202, and addressing the above problems.

In an example, FIG. 3 is a schematic diagram of a bracket provided in an embodiment of the present application. As shown in FIG. 3, the bracket 203 may be connected to the housing 301 of the electronic device through a plurality of connecting components 2031 extending out of the bracket 203. Specifically, the connecting components 2031 may be fixed on the housing 301 of the electronic device through bolts and bolt holes of the plurality of connecting components 2031. In another example, the bracket 203 may also be bonded or snap-fitted to the housing 301 of the electronic device. The specific connection method is not limited here.

In an implementation, when the apparatus for press detection receives a pressing operation, the relative distance between the first electrode 2041 and the second electrode 2042 changes, thus changing the capacitance of the sensor, such that the sensor generates a press signal. When the change of the relative distance between the first electrode 2041 and the second electrode 2042 varies, the capacitance change of the sensor varies, and press signals with different signal strengths are generated (for example: current change varies when the press signal is a current signal, and voltage change varies when the press signal is a voltage signal), and the relative distance between the first electrode 2041 and the second electrode 2042 changes significantly when a great pressing force is applied for the pressing operation. Therefore, the magnitude of the change of the relative distance between the first electrode 2041 and the second electrode 2042 can be determined based on the signal strength of the press signal, thereby determining the pressing force of the pressing operation received by the apparatus for press detection. For example, a great pressing force is applied when the press signal has a large strength, and a small pressing force is applied when the press signal has a small strength. Therefore, the magnitude of the pressure of the pressing operation can be determined by pressure detection on the pressing operation.

It should be noted that one of the first electrode 2041 and the second electrode 2042 serves as a driving electrode to receive a driving signal generated by the control unit on the circuit board 202. The control unit may be, e.g., a touch chip or a press detection chip, and the other one of the first electrode 2041 and the second electrode 2042 serves as a receiving electrode to output the press signal to the control unit on the circuit board, thereby achieving press detection. Preferably, the second electrode 2042 serves as the driving electrode to receive the driving signal transmitted from the circuit board 202, and the first electrode 2041 serves as the receiving electrode to generate a sensing signal. As the receiving electrode, the first electrode 2041 at least features benefits of: 1. The first electrode 2041 is located in a fixed region on the circuit board, will not move or deform, and has stable electrical properties. 2. A ground wire or a shielding layer may be disposed around the receiving electrode, to protect the generated sensing signal from external noise interference and improve the detection sensitivity.

In an embodiment of the present disclosure, the apparatus for press detection comprises the circuit board 202, the bracket 203, and the plurality of sensors. When the apparatus for press detection receives the pressing operation, the relative distance between the first electrode 2041 and the second electrode 2042 of each of the sensors changes, such that each of the sensors generates the press signal, and the circuit board 202 can transmit the press signal to the control unit to recognize the pressing operation of the user. Since no physical button is provided, the touch-sensitive region has a larger area than the touch pad in the single button form in the prior art. Since the pressing position is not limited, the apparatus for press detection can generate the press signal upon receipt of the pressing operation. Therefore, compared with the touch pad in the semi-area press form in the prior art, the user can press anywhere without the need to press at a particular position, thereby improving the user experience. Moreover, the first accommodating groove 206 is provided in the region around the sensors on the bottom surface of the circuit board 202, such that after the second electrode 2042 is welded to the circuit board, residual flux can be accommodated in the first accommodating groove 206, thereby preventing the flux from remaining on the surface of the circuit board 202 and affecting the press detection sensitivity, and endowing the apparatus for press detection with high sensitivity.

In a possible implementation, as shown in FIG. 2, the apparatus for press detection further comprises a cover plate 201 with an upper surface of the cover plate 201 providing a pressing surface and a bottom surface of the cover plate 201 contacting with the upper surface of the circuit board 202. The upper surface and the bottom surface of the cover plate 201 are opposite to each other, and the upper surface and the bottom surface of the circuit board 202 are opposite to each other. When the cover plate 201 is pressed, the apparatus for press detection receives the pressing operation.

The upper surface of the cover plate 201 provides the pressing surface. In an example, the cover plate 201 may be a cover plate 201 made of a glass material. The circuit board 202 is disposed between the sensor and the cover plate 201. When the cover plate 201 is pressed, for example: the user presses the cover plate 201, the apparatus for press detection receives the pressing operation, and the cover plate 201 drives the circuit board 202 to move in the pressure direction relative to the bracket 203. In this case, the bracket 203 is fixed on the housing 301 of the electronic device, the circuit board 202 shifts relative to the bracket 203, the first electrode 2041 is disposed on the circuit board 202, and the second electrode 2042 abuts against the bracket 203. When the circuit board 202 shifts relative to the bracket 203, the second electrode 2042 is configured to deform, thereby changing the relative distance between the first electrode 2041 and the second electrode 2042, changing the capacitance of the sensor, enabling the sensor to generate the press signal, and recognizing the user's pressing operation. In an example, as shown in FIG. 2, the cover plate 201 can be bonded to the circuit board 202 through a first adhesive layer 401.

In an implementation, the circuit board 202 may be a circuit board 202 with a touch recognition function. In this case, the cover plate 201 may further provide a touch surface. When a finger slides on the cover plate 201, the circuit board 202 performs touch recognition on the finger sliding trajectory and generates a touch recognition signal. The circuit board 202 can transmit the touch recognition signal to a touch recognition chip on the circuit board 202 or a processing unit of the electronic device, such that the electronic device implements a relevant operation corresponding to the finger sliding, such as: moving the cursor, moving the page, or zooming the page, which will not be repeated here.

In an embodiment of the present disclosure, the apparatus for press detection further comprises the cover plate 201, thereby providing the pressing surface to the user. When the user presses the cover plate 201, the apparatus for press detection can receive the pressing operation, so that the apparatus for press detection can recognize the user's pressing operation. Since the pressing position is not limited, the cover plate 201 can generate the press signal upon being pressed. Therefore, compared with press detection solutions in the prior art, the user can press anywhere on the cover plate 201 without the need to press at any particular position, thereby improving the user experience.

FIG. 4 is a schematic diagram of a circuit board provided in an embodiment of the present disclosure. As shown in FIG. 4, the circuit board 202 is provided with a annular electrical connection region 205. The electrical connection region 205 is used for electrical connection with the second electrode 2042, the first electrode 2041 is provided within an inner edge of the electrical connection region 205, and the first accommodating groove 206 is disposed around an outer edge of the electrical connection region 205.

The electrical connection region 205 on the circuit board 202 may be an electrical connection region 205 distributed in an annular arrangement. In an example, as shown in FIG. 4, the electrical connection region 205 may be an annular ring electrical connection region 205, the first electrode 2041 is disposed within the inner edge of the electrical connection region 205, and the second electrode 2042 may be welded to the electrical connection region 205, such that the second electrode 2042 is disposed opposite to the first electrode 2041. It should be understood that the contact area between the annular electrical connection region 205 and the second electrode 2042 is larger than the contact area between the electrical connection region 205 of an additional shape and the second electrode 2042. For example, compared to a point-shaped electrical connection region 205 and a rectangular electrical connection region having an equal area to the annular electrical connection region 205, the contact area between the annular ring electrical connection region 205 and the second electrode 2042 is larger. The first accommodating groove 206 is disposed around the outer edge of the electrical connection region 205. That is, as shown in FIG. 4, the first accommodating groove 206 is an annular accommodating groove with the inner edge of the annular accommodating groove contacting with the outer edge of the annular electrical connection region 205.

In an embodiment of the present disclosure, the circuit board 202 is provided with the annular electrical connection region 205, the electrical connection region 205 is electrically connected to the second electrode 2042, the first electrode 2041 is disposed within the inner edge of the electrical connection region 205, and the first accommodating groove 206 is disposed around the outer edge of the electrical connection region 205. The first accommodating groove 206 surrounding the outer edge of the electrical connection region 205 can accommodate the residual flux on the bottom surface of the circuit board 202 when the second electrode 2042 is welded, thereby preventing the flux from remaining on the surface of the circuit board 202 and affecting the press detection sensitivity, and improving the user experience.

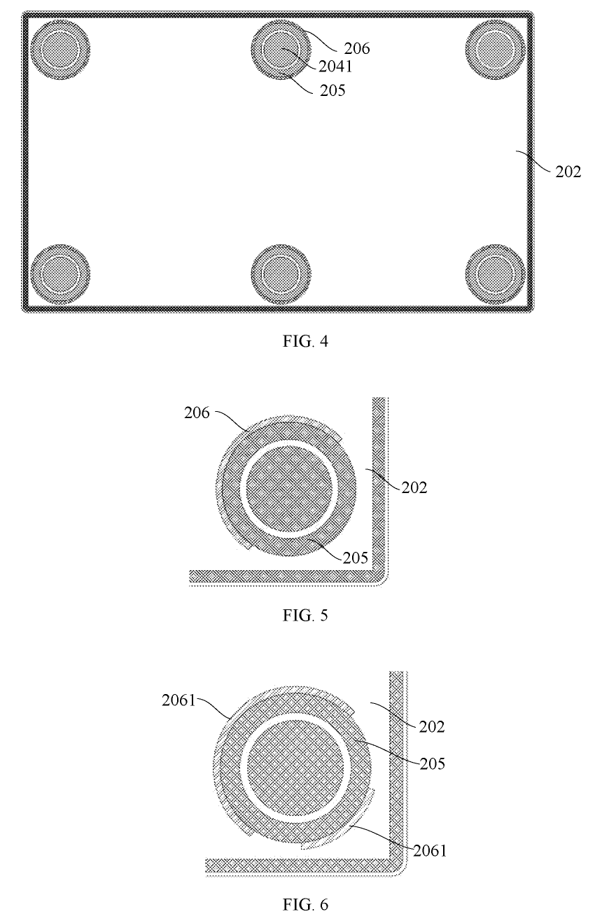

FIG. 5 is a schematic diagram of a first accommodating groove provided in an embodiment of the present disclosure. As shown in FIG. 5, the first accommodating groove 206 is an arc-shaped groove and an inner edge of the first accommodating groove 206 is in contact with the outer edge of the electrical connection region 205.

FIG. 5 shows an enlarged view of a partial region of the circuit board 202. As shown in FIG. 5, for a case where the electrical connection region 205 is close to an edge of the circuit board, the first accommodating groove 206 may be an arc-shaped groove, for example: a C-shaped groove as shown in FIG. 5, that is, the first accommodating groove 206 is disposed only around a part of the electrical connection region 205, and the inner edge of the arc-shaped groove contacts with the outer edge of the annular electrical connection region 205.

In an embodiment of the present disclosure, the first accommodating groove 206 is the arc-shaped groove, and the inner edge of the first accommodating groove 206 is in contact with the outer edge of the electrical connection region 205. Therefore, the first accommodating groove 206 may be provided only in a partial region of the outer edge of the electrical connection region 205, which is adaptable to a case failure to provide the first accommodating groove 206 in a partial region outside the electrical connection region 205 due to close proximity to the edge of the circuit board 202. Moreover, the first accommodating groove 206, as the arc-shaped groove, has a smaller grooved region on the circuit board 202 than the annular groove as shown in FIG. 4, and can reduce the costs.

FIG. 6 is a schematic diagram of another first accommodating groove provided in an embodiment of the present disclosure. As shown in FIG. 6, the first accommodating groove 206 comprises at least two accommodating sub-grooves 2061, and each of the accommodating sub-grooves 2061 is an arc-shaped groove, an inner edge of each of the at least two accommodating sub-grooves 2061 is in contact with the outer edge of the electrical connection region 205, and the at least two accommodating sub-grooves 2061 are not connected to each other.

Similar to the principle of the solution as shown in FIG. 5, when the electrical connection region 205 is close to the edge of the circuit board 202, a part of the region surrounding the electrical connection region 205 fails to be grooved. In this case, the first accommodating groove 206 may be disposed only around a part of the electrical connection region 205. As shown in FIG. 6, the first accommodating groove 206 may comprise at least two accommodating sub-grooves 2061, the inner edge of each of the accommodating sub-grooves 2061 contacts with the outer edge of the electrical connection region 205, and the at least two accommodating sub-grooves 2061 can form the first accommodating groove 206 distributed in an annular arrangement.

In an embodiment of the present disclosure, the first accommodating groove 206 comprises at least two accommodating sub-grooves 2061, and each of the accommodating sub-grooves 2061 is an arc-shaped groove, the inner edge of each of the at least two accommodating sub-grooves 2061 is in contact with the outer edge of the electrical connection region 205, and the at least two sub-grooves 2061 are not connected to each other. The two accommodating sub-grooves 2061 can form the first accommodating groove 206 distributed in an annular arrangement, which is adaptable to a case of failure to provide the first accommodating groove 206 in the partial region outside the electrical connection region 205 due to close proximity to the edge of the circuit board 202, and can increase the volume of the first accommodating groove 206, compared with the first accommodating groove 206 as the arc-shaped groove in the above embodiments, such that the first accommodating groove 206 can accommodate more residual flux.

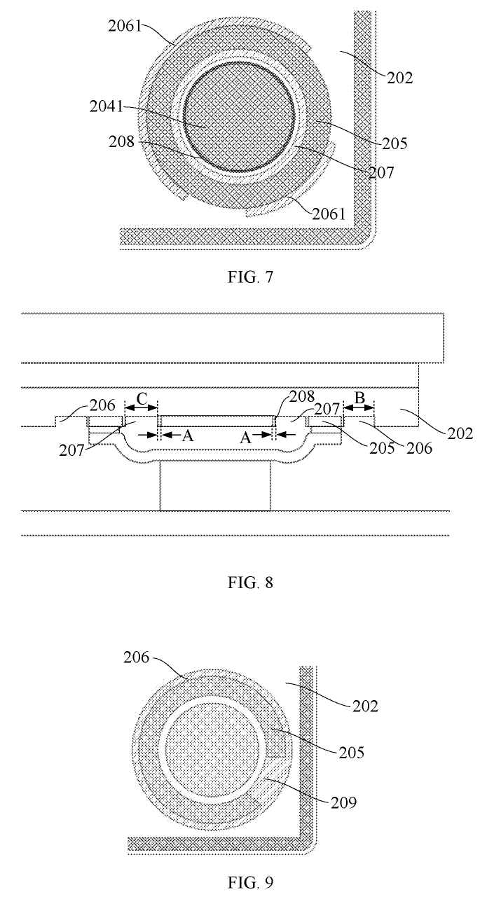

FIG. 7 is a schematic diagram of a circuit board comprising a second accommodating groove provided in an embodiment of the present disclosure. As shown in FIG. 7, a second accommodating groove 207 is provided on the bottom surface of the circuit board 202, the second accommodating groove 207 is disposed between the electrical connection region 205 and the first electrode 2041, a first insulating layer 208 is provided between the second accommodating groove 207 and the first electrode 2041, and the first insulating layer 208 has a thickness of greater than or equal to 0.05 mm in a direction parallel to the circuit board 202.

A second accommodating groove 207 may be additionally provided between the electrical connection region 205 and the first electrode 2041, and the second accommodating groove 207 may be an annular groove, an arc-shaped groove, or a groove of an additional shape. The second accommodating groove 207 plays the same role as the first accommodating groove 206 in accommodating the residual flux on the bottom surface of the circuit board 202 after the second electrode 2042 is welded to the circuit board 202. It should be understood that after the second electrode 2042 is welded to the circuit board 202, the second electrode 2042 is disposed opposite to the first electrode 2041. During the welding, the flux will flow into the space between the first electrode 2041 and the second electrode 2042 at a high temperature. The second accommodating groove 207 is provided to accommodate the residual flux flowing into the space between the first electrode 2041 and the second electrode 2042.

The first electrode 2041 further comprises the first insulating layer 208. The first insulating layer 208 is disposed on a side surface of the first electrode 2041. In an example, FIG. 8 is an enlarged section view of a local region of a circuit board provided in an embodiment of the present disclosure. As shown in FIG. 8, in a horizontal direction, the first insulating layer 208 is disposed between the first electrode 2041 and the second accommodating groove 207, and the first insulating layer 208 has a thickness of greater than or equal to 0.05 mm, that is, the length A in FIG. 8 is greater than or equal to 0.05 mm.

In an embodiment of the present disclosure, the second accommodating groove 207 is disposed on the bottom surface of the circuit board 202. The second accommodating groove 207 is disposed between the electrical connection region 205 and the first electrode 2041, thereby accommodating the residual flux flowing into the space between the first electrode 2041 and the second electrode 2042 in the second accommodating groove 207, preventing the flux from remaining between the first electrode 2041 and the second electrode 2042, from causing the second electrode 2042 to deform and then from causing the sensor to generate a small amount of signal, and improving the press detection sensitivity. Further, the first insulating layer 208 is disposed between the first electrode 2041 and the second accommodating groove 207, and the first insulating layer 208 has a thickness of greater than or equal to 0.05 mm, thereby preventing the first electrode 2041 from being electrically connected to an external component, preventing short-circuit failure of the sensor, and improving the reliability of the apparatus for press detection.

FIG. 9 is a schematic diagram of an electrical connection region provided in an embodiment of the present disclosure. As shown in FIG. 9, the electrical connection region 205 is an arc-shaped sheet structure, a third accommodating groove 209 is provided in a region between two ends of the electrical connection on the bottom surface of the circuit board 202, and the third accommodating groove 209 is connected to the first accommodating groove 206.

In addition to the annular arrangement as shown in FIG. 4, the electrical connection region 205 may also be the arc-shaped sheet structure. For example: the electrical connection region 205 shown in FIG. 9 presents a C-shaped sheet structure, and the third accommodating groove 209 is disposed in the region between the two ends of the electrical connection on the bottom surface of the circuit board 202. For example, the third accommodating groove 209 is disposed in the C-shaped notch in FIG. 9, the third accommodating groove 209 is a groove structure, and the third accommodating groove 209 is connected to the first accommodating groove 206.

In an embodiment of the present disclosure, the electrical connection region 205 is the arc-shaped sheet structure, thereby reducing the area of the electrical connection region 205, and reducing the costs. Further, the third accommodating groove 209 is disposed in the region between the two ends of the electrical connection on the bottom surface of the circuit board 202. The third accommodating groove 209 is connected to the first accommodating groove 206. Therefore, without the need to arrange a groove between the electrical connection region 205 and the first electrode 2041 (such as the second accommodating groove 207 shown in FIG. 7 in the above embodiments), the residual flux remaining between the first electrode 2041 and the second electrode 2042 can flow into the third accommodating groove 209 and flow into the first accommodating groove 206 through the third accommodating groove 209, thereby reducing the costs while accommodating the flux between the first electrode 2041 and the second electrode 2042.

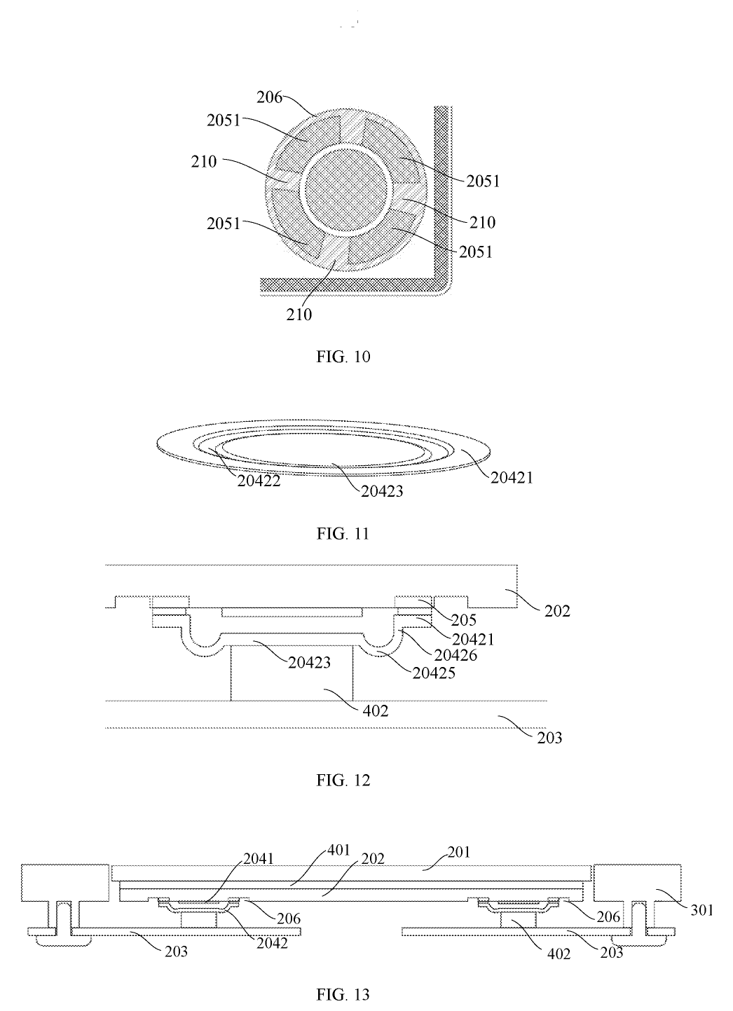

FIG. 10 is a schematic diagram of another electrical connection region provided in an embodiment of the present disclosure. As shown in FIG. 10, the electrical connection region 205 comprises at least two electrical connection sub-regions 2051, each of the electrical connection sub-regions 2051 is an arc-shaped sheet structure, and the at least two electrical connection sub-regions 2051 are distributed in an annular arrangement. A fourth accommodating groove 210 is provided in a region between adjacent electrical connection sub-regions 2051 on the bottom surface of the circuit board 202, and the fourth accommodating groove 210 is connected to the first accommodating groove 206.

The electrical connection region 205 may also be a split structure. Specifically, the electrical connection region 205 comprises at least two electrical connection sub-regions 2051, and the at least two electrical connection sub-regions 2051 are distributed in an annular arrangement. For example, FIG. 10 shows a annular electrical connection region 205 formed from 4 electrical connection sub-regions 2051. Each of the electrical connection sub-regions 2051 is the arc-shaped sheet structure.

The fourth accommodating groove 210 is disposed between adjacent electrical connection sub-regions 2051. Each fourth accommodating groove 210 is connected to the first accommodating groove 206. Similar to the principle of the third accommodating groove 209 in the above embodiments, when the second electrode 2042 is welded to the bottom surface of the circuit board 202, the residual flux remaining between the first electrode 2041 and the second electrode 2042 can flow into the fourth accommodating groove 210 and can flow into the first accommodating groove 206 through the fourth accommodating groove 210, to accommodate the residual flux between the first electrode 2041 and the second electrode 2042.

In an embodiment of the present disclosure, the electrical connection region 205 comprises at least two electrical connection sub-regions 2051, and each of the electrical connection sub-regions 2051 is the arc-shaped sheet structure. The at least two electrical connection sub-regions 2051 are distributed in an annular arrangement, and feature lower costs than the completely annular electrical connection region 205. Further, the fourth accommodating groove 210 is disposed in the region between adjacent electrical connection sub-regions 2051 on the bottom surface of the circuit board 202, and the fourth accommodating groove 210 is connected to the first accommodating groove 206. Therefore, without the need to arrange a groove (such as the second accommodating groove 207 shown in FIG. 7 in the above embodiments) between the electrical connection region 205 and the first electrode 2041, the residual flux remaining between the first electrode 2041 and the second electrode 2042 can flow into the fourth accommodating groove 210 and flow into the first accommodating groove 206 through the fourth accommodating groove 210, thereby reducing the costs while accommodating the flux between the first electrode 2041 and the second electrode 2042.

FIG. 11 is a schematic diagram of a second electrode provided in an embodiment of the present disclosure. As shown in FIG. 11, the second electrode 2042 comprises a sensing portion 20423, a deformation portion 20422, and a connecting portion 20421 that are formed as an integral piece. The sensing portion 20423 is a disc-shaped sheet structure, and the connecting portion 20421 is an annular ring structure. A radius of the sensing portion 20423 is smaller than an inner circle radius of the connecting portion 20421, the sensing portion 20423 is connected to the connecting portion 20421 through the deformation portion 20422, the sensing portion 20423 and the connecting portion 20421 are located on different planes, and a center-to-center line between the sensing portion 20423 and the connecting portion 20421 is perpendicular to the circuit board 202. The connecting portion 20421 is welded to the electrical connection region 205, and the sensing portion 20423 is disposed opposite to the first electrode 2041 in a direction perpendicular to the circuit board 202. When the apparatus for press detection receives the pressing operation, the deformation portion 20422 is configured to deform, and the sensing portion 20423 moves in a direction toward the first electrode 2041, changing a distance between the first electrode 2041 and the sensing portion 20423, such that the sensor generates the press signal.

The sensing portion 20423 is connected to the connecting portion 20421 through the deformation portion 20422. The sensing portion 20423 is the disc-shaped sheet structure, and the connecting portion 20421 is the annular ring structure. It should be understood that due to the spacing between the circuit board 202 and the bracket 203, the connecting portion 20421 and the sensing portion 20423 are not on a same plane, so that the connecting portion 20421 is electrically connected to the circuit board 202, and the sensing portion 20423 abuts against the bracket 203. Further, since the radius of the sensing portion 20423 is smaller than the inner circle radius of the connecting portion 20421, the deformation portion 20422 may be a hollow frustum-shaped structure as shown in FIG. 2, an edge of the large circular surface of the deformation portion 20422 with the frustum-shaped structure is connected to an inner circle of the connecting portion 20421, and an edge of a small circular surface of the deformation portion 20422 with the frustum-shaped structure is connected to an edge of the sensing portion 20423. Thus, the sensing portion 20423, the deformation portion 20422, and the connecting portion 20421 are combined to form the disc-shaped second electrode 2042.

The center-to-center line between the sensing portion 20423 and the connecting portion 20421 is perpendicular to the circuit board 202, that is, centers of the sensing portion 20423 and the connecting portion 20421 are located on a straight line in the direction perpendicular to the circuit board 202, that is, a projection of the sensing portion 20423 and a projection of the connecting portion 20421 on the circuit board 202 are homocentric in the direction perpendicular to the circuit board 202.

When the apparatus for press detection receives the pressing operation, for example, when the upper surface of the cover plate 201 is pressed, the cover plate 201 drives the circuit board 202 to move relative to the bracket 203, so that the relative distance between the circuit board 202 and the bracket 203 is reduced. In this case, because the sensing portion 20423 abuts against the bracket 203, the circuit board 202 drives the connecting portion 20421 to move downward, so that the deformation portion 20422 is configured to deform, the relative distance between the first electrode 2041 and the sensing portion 20423 is reduced, and the sensor generates the press signal. When pressing of the upper surface of the cover plate 201 is stopped, the deformation portion 20422 springs back, the circuit board 202 moves relative to the bracket 203, the relative distance between the circuit board 202 and the bracket 203 increases, and the relative distance between the first electrode 2041 and the sensing portion 20423 increases, until the relative distance between the first electrode 2041 and the sensing portion 20423 restores to the initial state, and the sensor stops generating the press signal.

In an example, the second electrode 2042 may be formed as an integral piece by stamping a metal sheet. For example, the second electrode 2042 may be formed by stamping a steel sheet. The material of the second electrode 2042 may be a metal or a metal alloy, such as stainless steel 304 or stainless steel 301. For example, the material of the second electrode 2042 may be stainless steel+nickel plating, or beryllium copper+nickel plating.

In an implementation, a center-to-center line between the annular ring electrical connection region 205 and the connecting portion 20421 is perpendicular to the circuit board 202. In an example, after the connecting portion 20421 is electrically connected to the electrical connection region 205 on the circuit board 202, the electrical connection region 205 is located inside the connecting portion 20421, that is, both an inner circle and an outer circle of the electrical connection region 205 are located between an inner circle and an outer circle of the connecting portion 20421.

In an embodiment of the present disclosure, the second electrode 2042 comprises the deformation portion 20422, the connecting portion 20421, and the sensing portion 20423. The connecting portion 20421 is electrically connected to the circuit board 202, the deformation portion 20422 connects the sensing portion 20423 to the connecting portion 20421, and the sensing portion 20423 abuts against the bracket 203. When the apparatus for press detection receives the pressing operation, the deformation portion 20422 is configured to deform, and the relative distance between the first electrode 2041 and the sensing portion 20423 changes, thereby generating a press signal, and achieving press detection. Since the deformation portion 20422 is disposed, when the apparatus for press detection receives the pressing operation, the deformation portion 20422 can deform, such that the sensor generates the press signal, and can spring back when the pressing is stopped, and so that the first electrode 2041 and the sensing portion 20423 restore to the initial state, thereby enabling the sensor to stop generating the press signal, and achieving the press detection.

FIG. 12 is a section view of a second electrode provided in an embodiment of the present disclosure. As shown in FIG. 12, the deformation portion 20422 comprises a first deformation sub-portion 20426 and a second deformation sub-portion 20425. A first end of the first deformation sub-portion 20426 is connected to the connecting portion 20421, a second end of the first deformation sub-portion 20426 is connected to a first end of the second deformation sub-portion 20425, a second end of the second deformation sub-portion 20425 is connected to the sensing portion 20423, and the second deformation sub-portion20425 has an arc-shaped section in the direction perpendicular to the circuit board 202.

The deformation portion 20422 may comprise the first deformation sub-portion 20426 and the second deformation sub-portion 20425. The second deformation sub-portion 20425 has a section of an arc-shaped structure in the direction perpendicular to the circuit board 202. In an implementation, as shown in FIG. 12, the second deformation sub-portion 20425 has a semicircular section, and the first deformation sub-portion 20426 may have a section of a sheet-like structure.

In an embodiment of the present disclosure, the deformation portion 20422 comprises the first deformation sub-portion 20426 and the second deformation sub-portion 20425. The second deformation sub-portion 20425 has the arc-shaped section in the direction perpendicular to the circuit board 202, so that the deformation portion 20422 of the second electrode 2042 presents a folded ring structure as a whole, which can reduce springback during stamping of the second electrode 2042, so that the deformation of the second electrode 2042 can be concentrated in the deformation portion 20422 with large deformation, thereby increasing the amount of signal generated by the apparatus for press detection when the user applies a pressing force.

In a possible implementation, the distance between the first electrode 2041 and the sensing portion 20423 is in a range of [0.1 mm, 0.3 mm] in the direction perpendicular to the circuit board 202. Preferably, the distance between the first electrode 2041 and the sensing portion 20423 is 0.15±0.1 mm.

In an embodiment of the present disclosure, the distance between the first electrode 2041 and the sensing portion 20423 is in the range of [0.1 mm, 0.3 mm]. Therefore, when the relative distance between the first electrode 2041 and the sensing portion 20423 changes, the press signal with a large signal amount is generated, thereby preventing the control unit from failure to recognize the pressing operation because of a small signal amount of the press signal caused by a short relative distance between the first electrode 2041 and the sensing portion 20423, and improving the press detection sensitivity of the apparatus for press detection.

In a possible implementation, a difference between an outer circle radius and an inner circle radius of the electrical connection region 205 is greater than or equal to 1 mm when the connecting portion 20421 is electrically connected to the electrical connection region 205 through a conductive adhesive, and the difference between the outer circle radius and the inner circle radius of the electrical connection region 205 is 0.5 mm when the connecting portion 20421 is electrically connected to the electrical connection region 205 by the solder.

Due to the high reliability of electrical connection by the solder, the electrical connection region 205 may have a narrow width, and the electrical connection region 205 may have an annular ring width of greater than or equal to 0.5 mm, that is, the difference between the outer circle radius and the inner circle radius is greater than or equal to 0.5 mm. It should be understood that the annular ring electrical connection region 205 is a standard annular ring shape, that is, the inner circle and the outer circle are homocentric.

In an embodiment of the present disclosure, the difference between the outer circle radius and the inner circle radius of the electrical connection region 205 is greater than or equal to 0.5 mm, thereby ensuring the reliability of the electrical connection between the connecting portion 20421 and the electrical connection region 205, preventing the connecting portion 20421 from being electrically disconnected from the electrical connection region 205 under the action of an external force, and improving the reliability of the apparatus for press detection.

In a possible implementation, the first electrode 2041 is a disc-shaped sheet structure, and a center-to-center line between the first electrode 2041 and the electrical connection region 205 is perpendicular to the circuit board 202.

In some other examples, the first electrode 2041 may be, e.g., rectangular or triangular. It should be understood that since the electrical connection region 205 is a annular ring shape and the first electrode 2041 is to be disposed within the inner circle of the electrical connection region 205, compared to the first electrode 2041 of an additional shape, the disc-shaped first electrode 2041 has a larger area than the first electrode 2041 of the additional shape.

In an embodiment of the present disclosure, the first electrode 2041 is a disc-shaped sheet structure, the center-to-center between the first electrode 2041 and the electrical connection region 205 is perpendicular to the circuit board 202, and the disc-shaped first electrode 2041 has a larger area than the first electrode 2041 of the additional shape. Therefore, compared with the arrangement of the electrode of the additional shape, the disc-shaped first electrode 2041 can enable the sensor to generate the press signal with a large signal amount during press detection, thereby improving the press detection sensitivity.

In a possible implementation, the first electrode 2041 has an area of greater than or equal to 20 square millimeters.

In an embodiment of the present disclosure, the first electrode 2041 has the area of greater than or equal to 20 square millimeters, thereby generating the press signal with a large signal amount than the first electrode 2041 with a smaller area, and improving the press detection sensitivity.

In a possible implementation, the first accommodating groove 206 has a groove width of greater than or equal to 0.5 mm, that is, the distance B in FIG. 8 is greater than or equal to 0.5 mm. Preferably, the first accommodating groove 206 has the groove width of 1 mm.

In an embodiment of the present disclosure, the first accommodating groove 206 has the groove width of greater than or equal to 0.5 mm. The groove width of the first accommodating groove 206 is limited, to limit the accommodation capacity of the first accommodating groove 206, thereby accommodating more residual flux.

In a possible implementation, the second accommodating groove 207 has a groove width of greater than or equal to 0.25 mm, that is, the distance C in FIG. 8 is greater than or equal to 0.5 mm. Preferably, the second accommodating groove 207 has the groove width of 0.65 mm.

In an embodiment of the present disclosure, the second accommodating groove 207 has the groove width of greater than or equal to 0.25 mm. The groove width of the second accommodating groove 207 is limited, to limit the accommodation capacity of the second accommodating groove 207, thereby accommodating more residual flux between the first electrode 2041 and the second electrode 2042.

In a possible implementation, a difference between the inner circle radius of the electrical connection region 205 and a radius of the first electrode 2041 is greater than or equal to 0.3 mm.

The electrical connection region 205 is an annular ring electrical connection region 205, and the center-to-center line between the electrical connection region 205 and the first electrode 2041 is perpendicular to the circuit board 202. Therefore, the outer circle and the inner circle of the electrical connection region 205 and the first electrode 2041 are homocentric. When the difference between the inner circle radius of the electrical connection region 205 and the radius of the first electrode 2041 is greater than or equal to 0.3 mm, that is, the distance between the inner circle of the electrical connection region 205 and an edge of the first electrode 2041 is greater than or equal to 0.3 mm. Therefore, the deformed deformation portion 20422 can prevent the first electrode 2041 from contacting with the second electrode 2042, and can prevent the electrical connection region 205 from being electrically connected to the first electrode 2041 when it is electrically connected to the connecting portion 20421. For example, the first electrode 2041 is redundantly electrically connected to the electrical connection region 205 during electrical connection by the solder.

In an embodiment of the present disclosure, the difference between the inner circle radius of the electrical connection region 205 and the radius of the first electrode 2041 is greater than or equal to 0.3 mm, thereby preventing the deformed deformation portion 20422 from contacting with the first electrode 2041 and the second electrode 2042, preventing the electrical connection region 205 from being electrically connected to the first electrode 2041 when it is electrically connected the connecting portion 20421, and ensuring the normal operation of the sensor.

In a possible implementation, the radius of the sensing portion 20423 is greater than or equal to the radius of the first electrode 2041, and the first electrode 2041 is located within an edge of the projection of the sensing portion 20423 in the direction perpendicular to the circuit board 202.

The radius of the sensing portion 20423 is greater than or equal to the radius of the first electrode 2041, that is, the area of the sensing portion 20423 is greater than or equal to the area of the first electrode 2041, and a projection of the first electrode 2041 on the circuit board 202 is located within the projection of the sensing portion 20423 on the circuit board 202 in the direction perpendicular to the circuit board 202, that is, the first electrode 2041 is covered by the second electrode 2042 in the direction perpendicular to the circuit board 202.

In an implementation, a center-to-center line between the first electrode 2041 and the sensing portion 20423 is perpendicular to the circuit board 202, and the first electrode 2041 has an equal area to the sensing portion 20423.

In an embodiment of the present disclosure, the radius of the sensing portion 20423 is greater than or equal to the radius of the first electrode 2041, and the first electrode 2041 is located within the edge of the projection of the sensing portion 20423 in the direction perpendicular to the circuit board 202, so that the entire area of the first electrode 2041 is involved in press detection, thereby generating the press signal with a large signal amount, and improving the press detection sensitivity.

In a possible implementation, the first electrode 2041 is integrated into the bottom surface of the circuit board 202, or the first electrode 2041 is disposed on the bottom surface of the circuit board 202.

FIG. 13 is a schematic diagram of another apparatus for press detection provided in an embodiment of the present disclosure. As shown in FIG. 13, the first electrode 2041 can be bonded or welded to the bottom surface of the circuit board 202, and both the first electrode 2041 and the second electrode 2042 are electrically connected to the circuit board 202. In another implementation, as shown in FIG. 2, the first electrode 2041 may be integrated into the bottom surface of the circuit board 202.

It should be noted that, for the solution that the first electrode 2041 is integrated into the bottom surface of the circuit board 202 as shown in FIG. 2, the first electrode may be a metal layer in the circuit board. For example, the first electrode 2041 is formed by, e.g., copper plating at a corresponding position where the first electrode 2041 needs to be disposed on the circuit board 202, and for the solution that the first electrode 2041 is disposed on the bottom surface of the circuit board 202 as shown in FIG. 13, the first electrode 2041 may be bonded or welded to the first electrical connection region corresponding to the first electrode 2041 on the circuit board 202, for example, bonded using a conductive adhesive or electrically connected by the solder. In an example, the area of the first electrical connection region corresponding to the first electrode 2041 is less than or equal to that of the first electrode 2041, and after the first electrode 2041 is electrically connected to the first electrical connection region, an edge of the first electrical connection region is located within the edge of the first electrode 2041, so that the first electrode 2041 covers the first electrical connection region. It should be further noted that the first electrical connection region corresponding to the first electrode 2041 may be located outside an edge of the inner circle of the annular ring electrical connection region 205 corresponding to the second electrode 2042. Taking the round first electrical connection region as an example, the round first electrical connection region may be homocentric with the electrical connection region 205, and has a radius of smaller than the inner circle radius of the electrical connection region 205, so that the first electrical connection region is disposed outside the edge of the inner circle of the electrical connection region 205. It should be understood that the first electrical connection region is not connected to with the electrical connection region 205, thereby preventing the first electrode 2041 from being electrically connected to the second electrode 2042.

In an embodiment of the present disclosure, the first electrode 2041 is integrated on the bottom surface of the circuit board 202, or the first electrode 2041 is bonded to the bottom surface of the circuit board 202. When the first electrode 2041 is integrated on the bottom surface of the circuit board 202, the overall thickness of the sensor can be reduced, thereby reducing the thickness of the apparatus for press detection. When the first electrode 2041 is bonded to the bottom surface of the circuit board 202, and when the first electrode 2041 is damaged, the first electrode 2041 can be easily replaced without the need for special processing on the circuit board 202, thereby resulting in lower costs.

In a possible implementation, the plurality of sensors are distributed in proximity to an edge of the circuit board 202, and a distance between each of the plurality of sensors and the edge of the circuit board 202 is in a range of [10 mm, 15 mm].

As shown in FIG. 4, the plurality of sensors may be distributed at the edge of the circuit board 202. It should be understood that FIG. 4 only serves as an example. The number of sensors may be set as required. In an implementation, at least four sensors may be disposed and distributed at four corners of the circuit board 202. When the number of sensors is greater than 4, they may be uniformly distributed around the circuit board 202.

It should be understood that when the apparatus for press detection receives the pressing operation, for example: when the cover plate 201 is pressed, the edge of the circuit board 202 has a large displacement relative to the center of the circuit board 202. Therefore, the press sensors are distributed at the edge of the circuit board 202, and the distance between each of the sensors and the edge of the circuit board 202 is in the range of [10 mm, 15 mm], so that the press detection is more sensitive. Further, a spacing from the edge of the circuit board 202 may be available to facilitate arrangement of the first accommodating groove 206.

In an embodiment of the present disclosure, the plurality of sensors are distributed in proximity to the edge of the circuit board 202, and the distance between each of the plurality of sensors and the edge of the circuit board 202 is in the range of [10 mm, 15 mm], thereby improving the press detection sensitivity of the apparatus for press detection, and detecting the press signal even when the user applies a small pressing force, and improving the user experience. The spacing from the edge of the circuit board 202 may be available to facilitate the arrangement of the first accommodating groove 206, thereby accommodating the residual flux in the first accommodating groove 206, and improving the press detection sensitivity.

In a possible implementation, the sensing portion 20423 abuts against the bracket 203 through a silicone pad 402. A projection of the silicone pad 402 on the circuit board 202 is located within the edge of the projection of the sensing portion 20423 on the circuit board 202 in the direction perpendicular to the circuit board 202.

As shown in FIGS. 2 and 13, the sensing portion 20423 abuts against the bracket 203 through the silicone pad 402. In an example, one side of the silicone pad 402 is bonded to the sensing portion 20423, and the other side of the silicone pad 402 is bonded to the bracket 203. In an implementation, a distance between an edge of a surface of the silicone pad 402 contacting with the sensing portion 20423 and the edge of the sensing portion 20423 is greater than or equal to 5 mm. In an example, the silicone pad 402 may be a cylindrical silicone pad 402, with an upper surface of the silicone pad 402 contacting with the sensing portion 20423, a center-to-center line the upper surface of the silicone pad 402 and the sensing portion 20423 is perpendicular to the circuit board 202, and a difference between the radius of the sensing portion 20423 and a radius of the upper surface of the silicone pad 402 is greater than or equal to 0.25 mm.

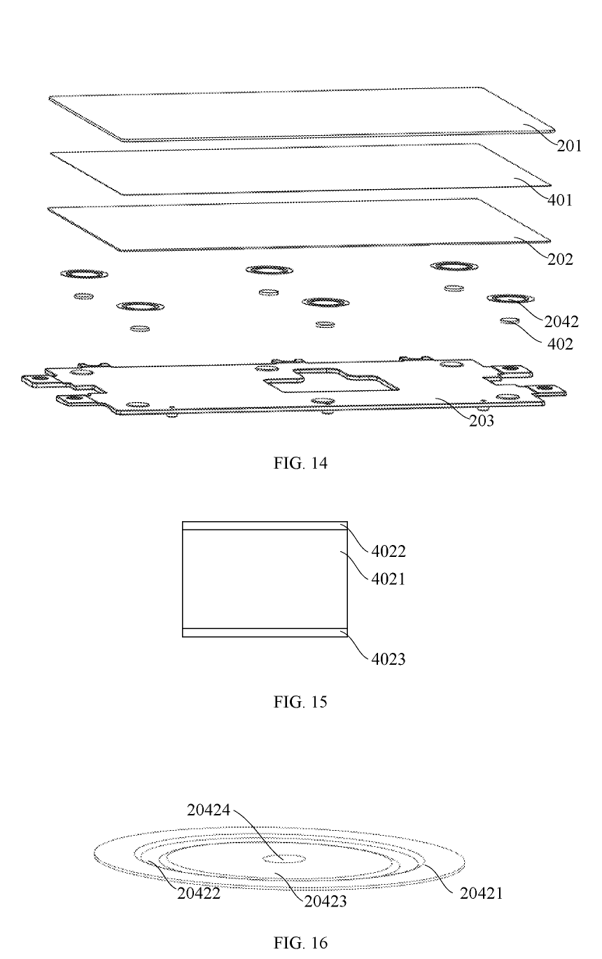

FIG. 14 is an exploded view of an apparatus for press detection provided in an embodiment of the present disclosure. As shown in FIG. 14, the bottom surface of the cover plate 201 is bonded to the upper surface of the circuit board 202 through the first adhesive layer 401. The upper surface and the bottom surface of the cover plate 201 are opposite to each other. The sensor comprises the first electrode 2041 and the second electrode 2042. The first electrode 2041 and the second electrode 2042 are connected to the bottom surface of the circuit board 202 respectively. The sensing portion 20423 in the second electrode 2042 abuts against the bracket 203 through the silicone pad 402. It should be understood that the second electrode 2042 is electrically connected to the circuit board 202 by the solder.

In an embodiment of the present disclosure, the sensing portion 20423 abuts against the bracket 203 through the silicone pad 402. Therefore, when the apparatus for press detection receives the pressing operation, after the relative distance between the circuit board 202 and the bracket 203 changes, the silicone pad 402 abuts against the sensing portion 20423, so that the deformation portion 20422 is configured to deform, and the relative distance between the sensing portions 20423 of the first electrode 2041 and the second electrode 2042 changes, thus generating the press signal. Further, the projection of the silicone pad 402 on the circuit board 202 is located within the edge of the projection of the sensing portion 20423 on the circuit board 202 in the direction perpendicular to the circuit board 202. Therefore, a force can be concentrated on the sensing portion 20423, so that the deformation portion 20422 in the second electrode 2042 can successfully deform, thereby ensuring that the apparatus for press detection can perform press detection normally.

FIG. 15 is a schematic diagram of a silicone pad provided in an embodiment of the present disclosure. As shown in FIG. 15, the silicone pad 402 comprises a first glue layer 4022, a second glue layer 4023, and silicone 4021. The silicone 4021 is disposed between the first glue layer 4022 and the second glue layer 4023, and the silicone pad 402 is bonded to the sensing portion 20423 and the bracket 203 through the first glue layer 4022 and the second glue layer 4023 respectively.

In an implementation, the first glue layer 4022 and the second glue layer 4023 may be a double-sided adhesive. In an implementation, the silicone 4021 has Shore hardness of A.

In an embodiment of the present disclosure, the silicone pad comprises the first glue layer 4022, the second glue layer 4023, and the silicone 4021. One surface of the silicone 4021 is bonded to the sensing portion 20423 through the first glue layer 4022, and the other surface of the silicone 4021 is bonded to the bracket 203 through the second glue layer 4023, so that the sensing portion 20423 abuts against the bracket 203 through the silicone pad 402. Therefore, when the apparatus for press detection receives the pressing operation, after the relative distance between the circuit board 202 and the bracket 203 changes, the silicone pad 402 abuts against the sensing portion 20423, so that the deformation portion 20422 is configured to deform, and the relative distance between the sensing portions 20423 of the first electrode 2041 and the second electrode 2042 changes, thus generating the press signal.

In a possible implementation, the silicone pad 402 is in a thickness range of [0.4 mm, 0.8 mm], the silicone 4021 is in a thickness range of [0.3 mm, 0.6 mm], and the first glue layer 4022 and the second glue layer 4023 are each in a thickness range of [0.05 mm, 0.2 mm]. Preferably, the silicone 4021 has a thickness of 0.4 mm, and each of the first glue layer 4022 and the second glue layer 4023 has a thickness of 0.1 mm.

In an embodiment of the present disclosure, the silicone pad 402 is in the thickness range of [0.4 mm, 0.8 mm], the silicone 4021 is in the thickness range of [0.3 mm, 0.6 mm], the first glue layer 4022 and the second glue layer 4023 are each in the thickness range of [0.05 mm, 0.2 mm], and the thickness of each part of the silicone pad 402 may be set as required, thereby ensuring that the deformation portion 20422 of the second electrode 2042 is configured to deform when the user applies a pressing force while reducing the overall thickness of the apparatus for press detection, thereby achieving the press detection function.

FIG. 16 is a schematic diagram of a sensing portion provided in an embodiment of the present disclosure. As shown in FIG. 16, the sensing portion 20423 of the second electrode 2042 comprises a first through hole 20424, an edge of the first through hole 20424 is located within an edge of the silicone pad 402, and the first through hole 20424 can balance air pressure on both sides of the second electrode 2042 in the direction perpendicular to the circuit board when the second electrode 2042 is electrically connected to the circuit board 202.

When the second electrode 2042 is electrically connected to the electrical connection region 205 on the circuit board 202, excess air between the second electrode 2042 and the circuit board 202 can be vented through the first through hole 20424, to balance the air pressure on both sides of the second electrode 2042 in the direction perpendicular to the circuit board 202. After electrically connected to the circuit board 202, the second electrode 2042 abuts against the bracket 203 through the silicone pad 402, with the silicone pad 402 covering the first through hole 20424 during the abutment, that is, the edge of the first through hole 20424 is located within an edge of the surface where the silicone pad 402 abuts against the second electrode 2042. The silicone pad 402 blocks one surface of the first through hole 20424 in proximity to the silicone pad 402, thus forming a sealed cavity between the second electrode 2042 and the first electrode 2041.

In an embodiment of the present disclosure, the sensing portion 20423 of the second electrode 2042 comprises the first through hole 20424 with the edge of the first through hole 20424 located within the edge of the silicone pad 402, thereby balancing the air pressure on both sides of the second electrode 2042 in the direction perpendicular to the circuit board 202 through the first through hole 20424 when the second electrode 2042 is assembled on the circuit board 202, and preventing occurrence of a gap in the electrical connection between the second electrode 2042 and the circuit board 202 due to the influence of air. Further, when the sensing portion 20423 of the second electrode 2042 abuts against the bracket 203 through the silicone pad 402, the silicone pad 402 blocks the first through hole 20424, to form a sealed cavity between the second electrode 2042 and the first electrode 2041, thereby preventing foreign particles or liquids from entering the space between the first electrode 2041 and the second electrode 2042, enhancing the dust and water resistance of the apparatus for press detection, and endowing the apparatus for press detection with high adaptability across diverse usage scenarios.

In a possible implementation, the first through hole 20424 is in a diameter range of [0.8 mm, 1.2 mm].

In an embodiment of the present disclosure, the first through hole 20424 is in the diameter range of [0.8 mm, 1.2 mm]. Therefore, when the second electrode 2042 is electrically connected to the circuit board 202, the air pressure on both sides of the second electrode 2042 is balanced in the direction perpendicular to the circuit board 202 through the first through hole 20424, the first through hole 20424 can be blocked by the silicone pad 402, and since the first through hole 20424 has a smaller diameter, the second electrode 2042 features higher reliability, compared to a case where a larger first through hole 20424 is disposed, thereby improving the reliability of the apparatus for press detection.

In a possible implementation, a surface of the first electrode 2041 is covered with a second insulating layer.

In an example, the second insulating layer covering the surface of the first electrode 2041 is an insulating ink, and the second insulating layer is disposed between the first electrode 2041 and the second electrode 2042. Specifically, after the insulating ink is coated on a surface of the circuit board 202, an opening is formed only on the electrical connection region 205, without forming an opening at a position corresponding to the first electrode 2041, so that the surface of the first electrode 2041 is covered with the insulating ink. In some other examples, the second insulating layer may be a second insulating layer made of an additional material, and the specific type of the second insulating layer is not limited here. In an implementation, the second insulating layer and the first insulating layer 208 may be formed as an integral piece.

In an embodiment of the present disclosure, the surface of the first electrode 2041 is covered with the second insulating layer, thereby preventing, when the relative distance between the sensing portion 20423 of the second electrode 2042 and the first electrode 2041 changes, the first electrode 2041 from contacting with the second electrode 2042, preventing the sensor from being short-circuited, enabling the sensor to normally generate the press signal, and improving the reliability of the apparatus for press detection.

In a possible implementation, the second electrode 2042 is made of a metal material, and the second electrode 2042 is in a thickness range of [0.1 mm, 0.2 mm].

In an example, the second electrode 2042 may be made of stainless steel, such as stainless steel 304 or stainless steel 301.

In an embodiment of the present disclosure, the second electrode 2042 is made of the metal material. Therefore, the second electrode 2042 can be energized after the second electrode 2042 is electrically connected to the circuit board 202. When the relative distance between the energized second electrode 2042 and the energized first electrode 2041 changes, the capacitance of the sensor changes, thereby generating the press signal, and the second electrode 2042 is in the thickness range of [0.1 mm, 0.2 mm], thereby improving the strength of the second electrode 2042 while ensuring the overall lightness and thinness of the apparatus for press detection, preventing the connecting portion 20421 of the second electrode 2042 from fracturing due to deformation, and improving the reliability of the apparatus for press detection.

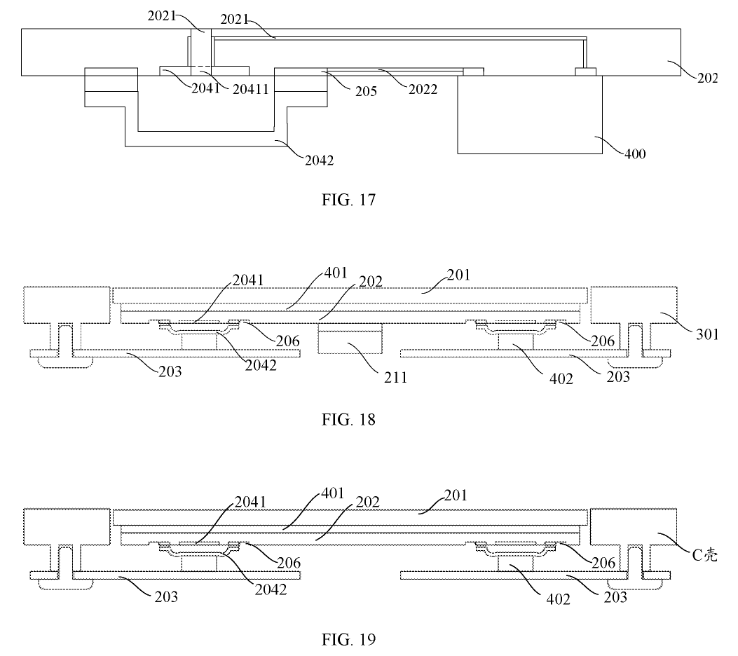

FIG. 17 is a schematic diagram of another circuit board provided in an embodiment of the present disclosure. As shown in FIG. 17, the circuit board 202 is provided with a first via hole 2021 that extends through the circuit board 202, the first electrode 2041 comprises a second through hole 20411, the second through hole 20411 is opposite to the first via hole 2021 in the direction perpendicular to the circuit board 202, the first electrode 2041 is electrically connected to the control unit 400 through an electrical connection wire accommodated in the first via hole 2021, and the second through hole 20411 can balance the air pressure on both sides of the second electrode 2042 in the direction perpendicular to the circuit board 202 when the second electrode 2042 is connected to the circuit board 202.

As shown in FIG. 17, the electrical connection region 205 on the circuit board 202 can accommodate the electrical connection wire and an electric connection wire of the control unit 400 in a second via hole 2022, and the second electrode 2042 can, after being electrically connected to the electrical connection region 205, be electrically connected to the control unit 400 through the electrical connection wire accommodated in the second via hole 2022. It should be understood that FIG. 17 only shows a schematic diagram of wiring, and the specific wiring method is not limited in the present disclosure. Specifically, the electrical connection region 205 and the first electrode 2041 can each be wired through the first accommodating groove 206, the second accommodating groove 207, the third accommodating groove 209, and the fourth accommodating groove 210.

In an embodiment of the present disclosure, the circuit board 202 is provided with the first via hole 2021, so that the first electrode 2041 is electrically connected to the control unit 400 by wiring through the first via hole 2021, and so that the first electrode 2041 is electrically connected. Further, since the second through hole 20411 is disposed on the first electrode 2041, the first via hole 2021 is opposite to the second through hole 20411, and the first via hole 2021 extends through the circuit board 202, thereby balancing the air pressure on both sides of the second electrode 2042 when the second electrode 2042 is electrically connected to the electrical connection region 205 on the circuit board 202. Compared with the solution that the first through hole 20424 is disposed on the sensing portion 20423 of the second electrode 2042 in the above embodiments, since no through hole may be provided on the second electrode 2042 when the through hole is provided on the first electrode 2041, the second electrode 2042 has higher strength, thereby improving the reliability of the apparatus for press detection.

In a possible implementation, the second through hole 20411 is in a diameter range of [0.15 mm, 0.3 mm].

In an embodiment of the present disclosure, the second through hole 20411 is in the diameter range of [0.15 mm, 0.3 mm], thereby ensuring that the first electrode 2041 has a large area, and preventing the first electrode 2041 with a small area caused by arrangement of a large second through-hole 20411 from resulting in the press signal with a low signal strength.

In a possible implementation, the bracket 203 has a thickness of greater than or equal to 0.5 mm.

The bracket 203 may be a bracket 203 made of various materials, including but not limited to a plastic, a stainless steel, a magnesium alloy, an aluminum alloy, a titanium alloy, etc. To ensure the strength of the bracket 203, the thickness of the bracket 203 is greater than or equal to 0.5 mm.

In an embodiment of the present disclosure, the thickness of the bracket 203 is greater than or equal to 0.5 mm, thereby ensuring the strength of the bracket 203, allowing the bracket 203 to be fixed on the housing 301 of the electronic device, and improving the reliability of the apparatus for press detection. Further, when the apparatus for press detection receives the pressing operation, for example: when the cover plate 201 is pressed, the bracket 203 with a higher strength is less likely to change its position than the bracket 203 with a lower strength, thereby ensuring that the distance between the circuit board 202 and the bracket 203 changes when the apparatus for press detection receives the pressing operation, generating the press signal, and ensuring that the apparatus for press detection can perform press detection normally.

In a possible implementation, a solder between the sensor and the circuit board 202 is in a thickness range of [30 μm-70 μm] in a direction perpendicular to the circuit board 202.

In an embodiment of the present disclosure, the solder between the sensor and the circuit board 202 is in the thickness range of [30 μm-70 μm] in the direction perpendicular to the circuit board 202, thereby ensuring the strength of the electrical connection between the circuit board 202 and the second electrode 2042 while ensuring the lightness and thinness of the apparatus for press detection, preventing the second electrode 2042 from being electrically disconnected from the circuit board 202, and improving the reliability of the apparatus for press detection.

In a possible implementation, FIG. 18 is a schematic diagram of an apparatus for press detection comprising a feedback unit provided in an embodiment of the present disclosure. As shown in FIG. 18, the apparatus for press detection further comprises the feedback unit 211. The feedback unit 211 is disposed on the bottom surface of the circuit board 202. After detecting the pressing operation, the control unit can send a feedback signal to the feedback unit 211. After receiving the feedback signal, the feedback unit 211 drives the apparatus for press detection to vibrate, thus providing vibration feedback to the user's pressing operation. In an implementation, the feedback unit 211 may be a linear vibration actuator (LRA) or a voice coil motor (VCM), and the number of feedback units 211 may be set as required.

In an embodiment of the present disclosure, the apparatus for press detection further comprises a feedback unit 211. When the user press is detected, the control unit can send the feedback signal to the feedback unit 211, so that the feedback unit 211 drives the circuit board 202 to vibrate, thus providing vibration feedback to the user's pressing operation, thereby simulating the hand feel of pressing a physical button, notifying the user that the pressing operation has been detected, and improving the user experience.

An embodiment of the present disclosure further provides an electronic device, comprising a housing 301 and the apparatus for press detection according to any one of the above embodiments. The bracket 203 in the apparatus for press detection is fixed on the housing 301.

In an example, the bracket 203 may be snap-fitted or bonded using a thermosetting adhesive to the housing 301 of the electronic device, and in another example, the bracket 203 may be fixed to the housing 301 of the electronic device through bolts, wherein the fixation is not limited here.

In a possible implementation, the electronic device comprises a notebook computer, and the bracket 203 in the apparatus for press detection is fixed to a C-cover of the notebook computer.

FIG. 19 is a section view of an electronic device provided in an embodiment of the present disclosure. As shown in FIG. 19, the bracket 203 in the apparatus for press detection is fixed to the C-cover of the notebook computer through bolts.

In an embodiment of the present disclosure, the bracket 203 in the apparatus for press detection can be fixed to the C-cover of the notebook computer, thereby fixing the bracket 203 on the housing 301 of the electronic device. Therefore, when the apparatus for press detection receives a pressing operation, for example, when the circuit board 202 is pressed, the second electrode 2042 on the bracket 203 can deform, so that the sensor 204 generates a press signal, thereby detecting the pressing operation.

It should be understood that the various embodiments in the present specification are described in a progressive manner, with identical or similar portions among the embodiments referring to one another, and each embodiment focuses on introduction of its distinctions from the other embodiments. In particular, the method embodiments are substantially similar to the method described in the apparatus and system embodiments, which are therefore relatively simply described. A part of description of other embodiments may be referred to for relevant details.

It should be understood that particular embodiments of the present specification are described above. Other embodiments are encompassed within the scope of the claims. In some cases, actions or steps disclosed in the claims may be implemented in an order different from that in the embodiments, and can still achieve desired results. In addition, the processes depicted in the drawings are not necessarily required to achieve the desired results in the shown particular order or in a sequential order. In some embodiments, multitasking and parallel processing may also be feasible, or may be advantageous.

It should be understood that an element described herein in a singular form or only one of the elements shown in the drawings does not mean that the number of the element is limited to one. Further, modules or elements described or shown as separate modules or elements herein may be combined into a single module or element, and a single module or element described or shown herein may be split into a plurality of modules or elements.

It should be further understood that the terms and expressions used herein are for description only, and one or more embodiments of the present specification should not be limited to these terms and expressions. The use of these terms and expressions does not mean to exclude equivalent features of any illustrations and descriptions (or parts thereof), and it should be appreciated that various possible modifications should also be included within the scope of the claims. There may also be other modifications, alterations, and replacements. Accordingly, the claims should be deemed to cover all these equivalents.

What is claimed is:

1. An apparatus for press detection applied to an electronic device, comprising: a circuit board, a bracket, and a plurality of sensors; wherein
each of the sensors comprises a first electrode disposed on a bottom surface of the circuit board and a second electrode connected to the bottom surface of the circuit board, a first accommodating groove is provided in a region around each of the sensors on the bottom surface of the circuit board, for accommodating residual flux when the second electrode is welded to the circuit board;
the bracket is fixed on a housing of the electronic device, and abuts against the second electrode;
when the apparatus for press detection receives a pressing operation, the second electrode is configured to deform, changing a distance between the first electrode and the second electrode, such that each of the sensors generates a press signal; and
the circuit board is configured to transmit the press signal to a control unit to enable the control unit to perform press detection based on the press signal.

2. The apparatus for press detection according to claim 1, wherein the circuit board is provided with an annular electrical connection region electrically connected to the second electrode, the first electrode is disposed within an inner edge of the electrical connection region, and the first accommodating groove is disposed around an outer edge of the electrical connection region.

3. The apparatus for press detection according to claim 2, wherein the first accommodating groove is an arc-shaped groove, and an inner edge of the first accommodating groove is in contact with the outer edge of the electrical connection region;
the first accommodating groove comprises at least two accommodating sub-grooves, wherein each of the accommodating sub-grooves is an arc-shaped groove, an inner edge of each of the accommodating sub-grooves is in contact with the outer edge of the electrical connection region, and the at least two sub-grooves are not connected to each other; or
a second accommodating groove is provided on the bottom surface of the circuit board, the second accommodating groove is disposed between the electrical connection region and the first electrode, a first insulating layer is provided between the second accommodating groove and the first electrode, and the first insulating layer has a thickness of greater than or equal to 0.05 mm in a direction parallel to the circuit board.

4. The apparatus for press detection according to claim 2, wherein the electrical connection region is an arc-shaped sheet structure, a third accommodating groove is provided in a region between two ends of the electrical connection region on the bottom surface of the circuit board, and the third accommodating groove is connected to the first accommodating groove; or
the electrical connection region comprises at least two electrical connection sub-regions, each of the electrical connection sub-regions is an arc-shaped sheet structure, the at least two electrical connection sub-regions are distributed in an annular arrangement, a fourth accommodating groove is provided in a region between adjacent electrical connection sub-regions on the bottom surface of the circuit board, and the fourth accommodating groove is connected to the first accommodating groove.

5. The apparatus for press detection according to claim 2, wherein the second electrode comprises a sensing portion, a deformation portion, and a connecting portion formed as an integral piece; wherein
the sensing portion is a disc-shaped sheet structure, the connecting portion is an annular ring structure, a radius of the sensing portion is smaller than an inner circle radius of the connecting portion, the sensing portion is connected to the connecting portion through the deformation portion, the sensing portion and the connecting portion are located on different planes, and a center-to-center line between the sensing portion and the connecting portion is perpendicular to the circuit board;
the connecting portion is welded to the electrical connection region, and the sensing portion is disposed opposite to the first electrode in a direction perpendicular to the circuit board; and
when the apparatus for press detection receives the pressing operation, the deformation portion is configured to deform, and the sensing portion moves in a direction toward the first electrode, changing a distance between the first electrode and the sensing portion, such that each of the sensors generates the press signal.

6. The apparatus for press detection according to claim 5, wherein the deformation portion comprises a first deformation sub-portion and a second deformation sub-portion, a first end of the first deformation sub-portion is connected to the connecting portion, a second end of the first deformation sub-portion is connected to a first end of the second deformation sub-portion, a second end of the second deformation sub-portion is connected to the sensing portion, and the second deformation sub-portion has an arc-shaped section in the direction perpendicular to the circuit board;
the distance between the first electrode and the sensing portion is in a range of [0.1 mm, 0.3 mm] in the direction perpendicular to the circuit board; or
a difference between an outer circle radius and an inner circle radius of the electrical connection region is greater than or equal to 1 mm; and a difference between an outer circle radius and the inner circle radius of the connecting portion is in a range of [1 mm, 1.6 mm], and is smaller than the difference between the outer circle radius and the inner circle radius of the electrical connection region.

7. The apparatus for press detection according to claim 2, wherein the first electrode is a disc-shaped sheet structure, and a center-to-center line between the first electrode and the electrical connection region is perpendicular to the circuit board.

8. The apparatus for press detection according to claim 7, wherein the first electrode has an area of greater than or equal to 20 square millimeters; or
a difference between an inner circle radius of the electrical connection region and a radius of the first electrode is greater than or equal to 0.3 mm.

9. The apparatus for press detection according to claim 1, wherein the first accommodating groove has a groove width of greater than or equal to 0.5 mm.

10. The apparatus for press detection according to claim 3, wherein the second accommodating groove has a groove width of greater than or equal to 0.25 mm.

11. The apparatus for press detection according to claim 1, wherein the first electrode is integrated into the bottom surface of the circuit board, or the first electrode is disposed on the bottom surface of the circuit board; or
the plurality of sensors are distributed in proximity to an edge of the circuit board, and a distance between each of the plurality of sensors and the edge of the circuit board is in a range of [10 mm, 15 mm].

12. The apparatus for press detection according to claim 11, wherein the sensing portion abuts against the bracket through a silicone pad, and a projection of the silicone pad on the circuit board is located within an edge of a projection of the sensing portion on the circuit board in the direction perpendicular to the circuit board.

13. The apparatus for press detection according to claim 12, wherein the silicone pad comprises a first glue layer, a second glue layer, and silicone disposed between the first glue layer and the second glue layer, and the silicone pad is bonded to the sensing portion and the bracket respectively through the first glue layer and the second glue layer.

14. The apparatus for press detection according to claim 13, wherein the silicone pad is in a thickness range of [0.4 mm, 0.8 mm], the silicone is in a thickness range of [0.3 mm, 0.6 mm], and the first glue layer and the second glue layer are each in a thickness range of [0.05 mm, 0.2 mm].

15. The apparatus for press detection according to claim 12, wherein the sensing portion comprises a first through hole, and an edge of the first through hole is located within an edge of the silicone pad; and
the first through hole is used to balance air pressure on both sides of the second electrode in the direction perpendicular to the circuit board when the second electrode is electrically connected to the circuit board.

16. The apparatus for press detection according to claim 15, wherein the first through hole is in a diameter range of [0.8 mm, 1.2 mm].

17. The apparatus for press detection according to claim 1, wherein a surface of the first electrode is covered with a second insulating layer;
the second electrode is made of a metal material, and the second electrode is in a thickness range of [0.1 mm, 0.2 mm]; or
a solder between the sensor and the circuit board is in a thickness range of [30 μm-70 μm] in a direction perpendicular to the circuit board.

18. The apparatus for press detection according to claim 1, wherein the circuit board is provided with a via hole that extends through the circuit board, the first electrode comprises a second through hole, and the second through hole is opposite to the via hole in a direction perpendicular to the circuit board;
the first electrode is electrically connected to the control unit through an electrical connection wire accommodated in the via hole; and
the second through hole is used to balance air pressure on both sides of the second electrode in a direction perpendicular to the circuit board when the second electrode is connected to the circuit board.

19. The apparatus for press detection according to claim 18, wherein the second through hole is in a diameter range of [0.15 mm, 0.3 mm].

20. An electronic device, comprising a housing and the apparatus for press detection according to claim 1; and
the bracket in the apparatus for press detection is fixed on the housing.
